(19) United States
(12) Patent Application Publication
(10) Pub. No.: US 2008/0112457 A1
(43) Pub. Date: May 15, 2008

(54) Calorimeter

(75) Inventor: Stelios Mores, Bedfordshire (GB)

Correspondence Address: KNOBBE MARTENS OLSON & BEAR LLP, 2040 MAIN STREET, FOURTEENTH FLOOR, IRVINE, CA, 92614, US

(73) Assignee: Health Scientific Co. Ltd., Milton Keynes (GB)

(21) Appl. No.: 11/570,536

(22) PCT Filed: Jul. 8, 2005
(86) PCT No.: PCT/GB05/02686

§ 371 Date: Sep. 4, 2007

(30) Foreign Application Priority Data
Jul. 16, 2004 (GB) 0415968.7

(51) Int. Cl. G01K 17/00

(52) U.S. Cl. 374/31

(57) ABSTRACT

A calorimeter and a method of performing calorimetric analysis are disclosed. The calorimeter comprises a sample chamber having a gas inlet and a gas outlet, a flow duct interconnecting the gas inlet and the gas outlet to form a flow circuit with the sample chamber. A pump is disposed within the flow circuit operable to cause gas to flow into the gas inlet. There is a heater to heat gas flowing within the flow circuit. There is a respective sensor, operable to detect the temperature of one or more sample within the sample chamber For use, the flow circuit is sealed such that gas within it is retained for circulation by the pump, the gas being heated by the heater before passing into the sample chamber to transfer heat to sample therein. In the method, one or more sample is placed in the sample chamber. The pump and the heater are then operated, while the output of the sensor is monitored to record the change of temperature of the sample over time.

The present invention relates to a calorimeter and in particular, but not exclusively, to a calorimeter instrument that is intended for screening material samples.

A commonly accepted method for the assessment of the thermal stability of chemicals is to increase the temperature of a small sample of the material in a linear fashion by utilising a heat source. When chemical activity within the sample of material begins, this activity is detected by means of temperature measurement equipment as heat generation, or heat consumption (depicted as negative heat generation). By characterising the heat generation of the material, well-understood laws of chemical thermodynamics and chemical kinetics can be used to determine fundamental chemical parameters of the sample. Safe operating parameters can also be determined from such information such as maximum process temperatures and maximum safe storage temperatures.

Simultaneous pressure measurement can also yield information on the thermal properties and behaviour of the material.

Differential scanning calorimeters (abbreviated to DSC) have been used over many years to test materials on a milligram scale against a reference. A DSC typically uses a temperature ramp test and compares the amount of energy input to the sample and to a reference material by a heater to maintain the required ramp rate. Thus, during a phase change, the sample will absorb heat and the heater power will be increased. A measurement of the heater power yields the heat required for the phase change. The same technique applies to analysis of reactions within the sample.

Whilst the DSC provides a very popular method for simple screening of the thermal safety of a material, it does not yield pressure data and the sample size is so small that only homogeneous materials can be studied. A sludge or slurry, or any sample with particulate matter in suspension cannot be represented accurately on a milligram scale.

An alternative known device is the RADEX, which is an instrument designed to test samples on the scale of 1 to 3 grams. It employs a ramped temperature environment with air being blown through a heater and then onto the sample. The air is not recirculated.

The thermal screening unit (TSU) is a furnace in which a single sample is placed and put through a ramped temperature profile. The sample size is 1 to 5 grams typically and there is no simultaneous reference. Thus, deviation from the temperature ramp may be more difficult to determine. A further drawback of using a furnace is the fact that characterisation of the flow behaviour of the convective and/or circulated air stream within is virtually impossible.

The advanced reactive system-screening tool (ARSST) is a pressurised furnace in which an open sample holder is placed and taken through a ramped temperature profile. However, pressure measurement is difficult to relate to real-world conditions, and the environment as a whole is somewhat artificial but the instrument is cheap and it is a relatively common device found in hazard assessment laboratories.

The aim of this invention is to provide a calorimeter to study the physico-chemical properties of single materials and mixtures. Its primary aim is to enable the identification of reactions in chemicals and mixtures, which may lead to the generation of high temperatures and/or pressures. In addition, it is an aim of the invention to provide a device that can quantify physical properties such as tempering points (melting point, boiling point, etc.) and critical points (saturated vapour to gas transition, etc.).

A further aim of the invention is to provide data rapidly, curtailing the need for extensive use of the more resource-intensive and time-intensive experimental techniques. The data generated by the device allows experimentalists (typically working in the fields of thermal safety and vent sizing) to decide which candidate systems to investigate further and which should be given less attention.

From a first aspect, this invention provides a calorimeter comprising a sample chamber having a gas inlet and a gas outlet, a flow duct interconnecting the gas inlet and the gas outlet to form a flow circuit with the sample chamber, a circulation pump within the flow circuit operable to cause gas to flow into the gas inlet, a heater to heat gas flowing within the flow circuit, and a sensor operable to detect the temperature of a sample within the sample chamber, wherein the flow circuit, during use, is sealed such that gas within it is retained for circulation by the circulation pump, the gas being heated by the heater before passing into the sample chamber to transfer heat to a sample therein.

The recirculation of gas within the flow circuit has been found to provide a stable and predictable way to provide the heat required to perform a detailed calorimetric analysis.

In addition to a sensor to measure the temperature of the sample, advantageously a sensor operable to detect a reference temperature may be provided. The reference temperature may be for example the temperature of the gas flowing within the flow circuit and/or the temperature of an inert sample in the sample chamber. By comparing the reference temperature with the temperature of a sample, useful data relating to chemical activity of the sample can be obtained. Additional useful data may be obtained by provision of an optional sensor operable to detect the pressure of gas flowing within the flow circuit. A further sensor may be used to monitor the heater temperature, for control purposes.

To ensure that the sample is heated evenly and predictably, a calorimeter embodying the invention may further comprise means for inducing turbulence in gas flowing within the flow circuit. Advantageously, the means for inducing turbulence is disposed between the pump and the sample chamber. This ensures that the gas entering the sample chamber has a particularly even heat distribution. The means for inducing turbulence may be an in-line mixing device, referred to herein as a “turbulator”.

Typically, the sample chamber is configured so that it can contain a plurality of separate samples. In such embodiments, a respective sensor may be provided to measure the temperature of each sample.

The heater is typically disposed within the flow circuit upstream of the circulation pump. By passing the heated air through the circulation pump, unevenness of temperature can be reduced. To ensure that predictable results can be obtained, the flow circuit may include ducts that are insulated to reduce loss of heat from the gas flowing within the flow circuit.

A port through which gas can be introduced into the flow circuit may be provided to purge the flow circuit of oxygen. Additionally, a port through which a cryogen can be introduced into the flow circuit can be provided to allow the analysis to start at a low temperature.

From a second aspect, this invention provides a method of performing an analysis on a sample, comprising: a) placing the sample in the sample chamber of a calorimeter embodying the first aspect of the invention; b) operating the pump to cause gas to flow within the flow circuit; c) operating the heater to convey heat to the gas flowing within the flow circuit; and d) using a sensor to monitor the temperature of one or more of the sample and the gas flowing within the flow circuit. The method may be applied to several samples simultaneously. It may also include measuring the temperature of a reference sample also placed within the sample chamber.

Prior to step (b), an inert gas, for example nitrogen, is advantageously introduced into the flow circuit. Prior to step (b), a cryogen, such as liquid nitrogen, may be introduced into the flow circuit to begin the analysis at a low temperature.

In step (d), the pressure of gas within the flow circuit may also be measured.

The heater is operated to create various temperature profiles. For example, it may raise the temperature of a reference (such as the recirculated gas), or each sample, at a constant rate. Optionally, this may be followed by a “soak” in which the heater is operated to maintain the temperature of a reference (such as the re-circulated gas) or the/each sample at a constant temperature during part of the analysis.

In these methods, the or each temperature and/or pressure measurement is recorded as a function of time.

An embodiment of the invention will now be described, by way of example, with reference to the accompanying drawings, in which:

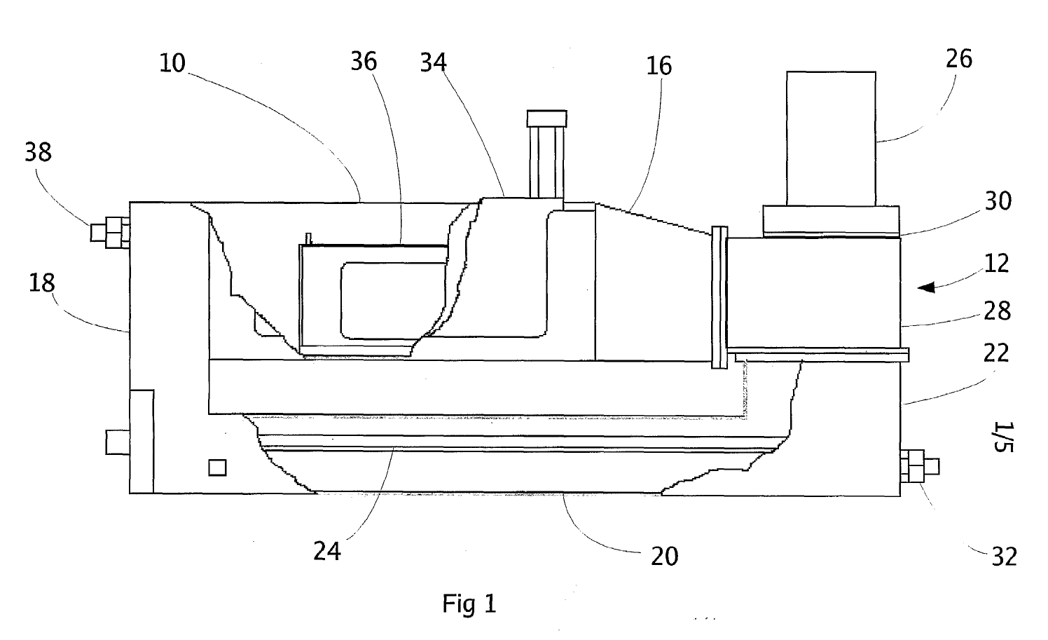

FIG. 1 is side view showing the general arrangement of an air duct that forms part of a calorimeter according to an embodiment of the invention;

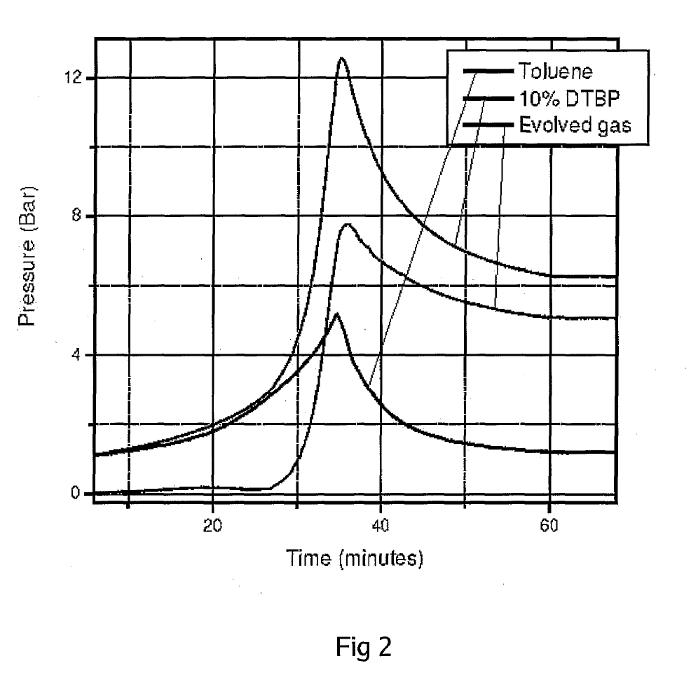

FIG. 2 is a graph illustrating pressure within an embodiment of the invention during an analysis of 10% Di-tert Butyl Peroxide (DTBP) dissolved in Toluene;

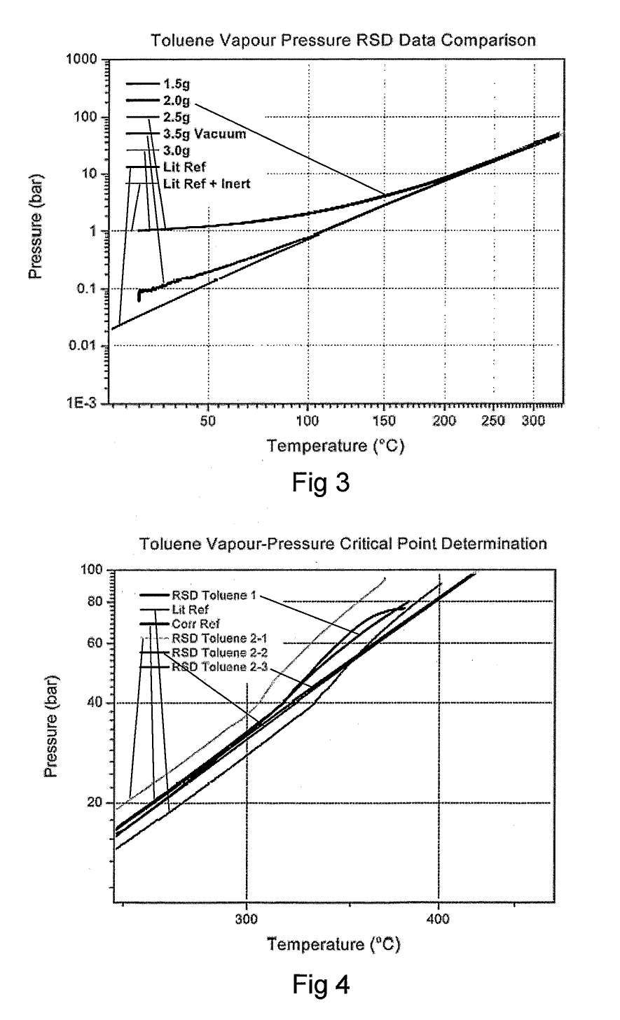

FIGS. 3 and 4 are graphs showing an analysis of toluene vapour pressure and critical point in an embodiment of the invention;

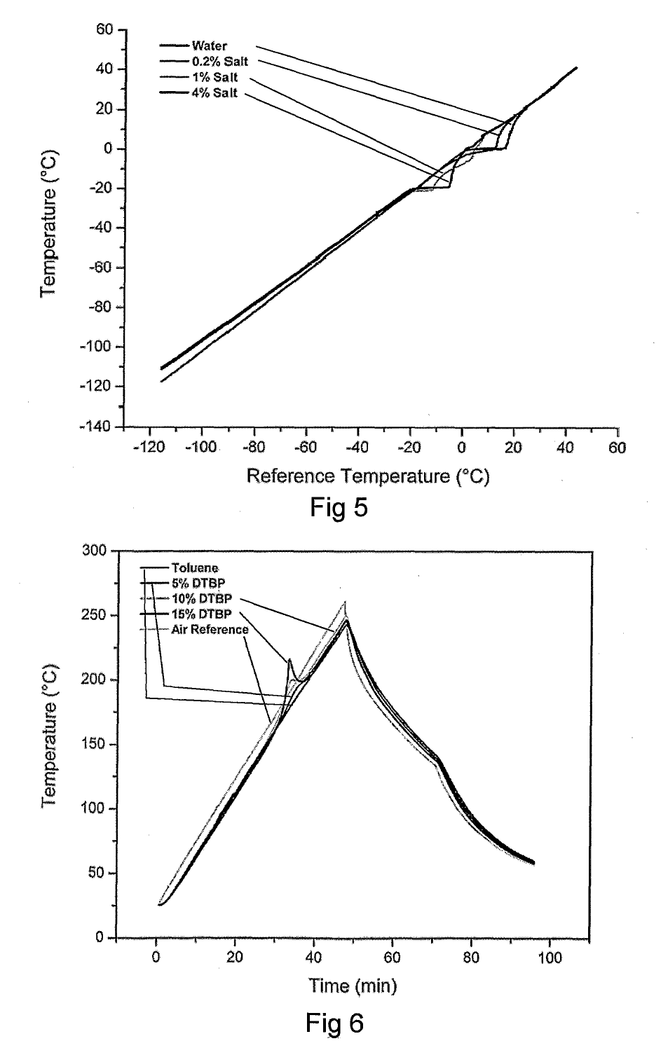

FIG. 5 is a graph showing temperature against reference temperature during cryogenic operation of an embodiment of the invention; and

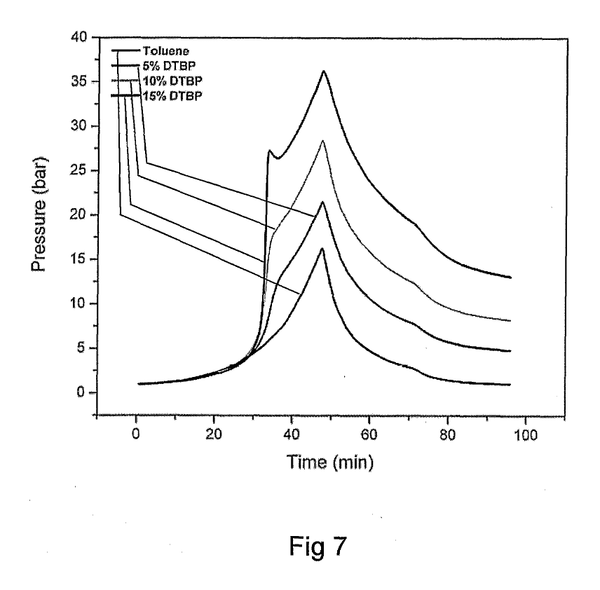

FIGS. 6 and 7 are graphs of temperature and pressure respectively against time during analysis of DTBP in Toluene in an embodiment of the invention.

The mechanical aspects of the instrument consist largely of metal ducting, which is constructed such that it forms a circuit as shown in FIG. 1.

The apparatus comprises a sample chamber 10 that is a generally square-sectioned tube. The sample or samples to be investigated are placed inside the sample chamber 10. The tube cross-section may vary in shape from one embodiment to another, although using a square form facilitates both manufacture and use.

A circulation pump or blower 12 capable of pumping gas has an outlet connected, through a duct and a turbulator 16, to an inlet end of the sample chamber 10. Return ducts 18, 20, 22, constructed from rectangular sectioned metal tube, connect an outlet end of the sample chamber to an inlet to the blower 12. These sections are made from steel tubing welded together to prevent the leakage of gas medium and to provide strength to resist damage from energetic materials. Alternative materials of construction may also be used. The blower 12, turbulator 16, sample chamber 10 and ducts 18, 20, 22, constitute a flow circuit around which gas can flow. As represented in FIG. 1, the flow direction is anti-clockwise. The blower 12 is selected to withstand high gas temperatures so that it can move the gas medium around the flow circuit at both low and high temperatures. The turbulator 16 is intended to ensure a homogeneous turbulent gas flow within the sample chamber 10.

A lower part of the duct 20 contains heaters 24 (e.g. electric resistance heaters), which are arranged to heat the gas medium within the flow circuit as is passes over the heaters 24, prior to being conveyed to the sample chamber 10 by the blower. The heaters 24 have a wide operating range allowing the system to reach from cryogenic temperatures (less than −120° C.) to elevated temperatures (greater than 1000° C.). Other heater types could also be used, but this could limit the operating range of the instrument. A sensor (not shown) may be provided for monitoring the temperature of the heater, for control purposes. The exterior of the ducting is sheathed in thermal insulation and ceramic tiles.

An opening in a side wall of the sample chamber 10 is provided with a removable lid 34. The lid 34 can be removed to allow a sample to be introduced into and removed from the sample chamber 10. Samples within the chamber 10 are held in a test cell 36 to ensure that circulating gas flows evenly over them. The sample chamber 10 includes sensors (not shown) for monitoring the temperature of the samples as well as a reference temperature, which may be the gas temperature and/or the temperature of an inert sample.

The blower 12 is designed for high-temperature operation with an electric drive motor 26 mounted away from the impeller and impeller housing 28. A ceramic tile 30 with low thermal conductivity is used as a stand-off between the motor and impeller housing and a fan is mounted on the shaft of the motor in order to provide air circulation and cooling for the motor.

The path of the gas flow is such that it is first heated and then passes through the blower 12, which provides mixing of the gas and therefore reduced spatial temperature gradients. The gas then flows through the turbulator 16, which induces turbulent flow in the gas stream. A well-mixed, turbulent stream of gas therefore flows through the sample chamber 10, ensuring even and consistent heat delivery to all chemical samples within its volume. After leaving the sample chamber 10 the gas is re-circulated through the ducts 18, 20, 22.

At the end of an experiment, it is useful if the equipment can be quickly cooled from the elevated temperatures achieved during testing. To this end, a port that contains a valve 32 is connected to a compressed gas supply and opened at the end of the experiment allowing gas to flow into the ducting and cool the system rapidly. A similar arrangement is also used at the beginning of an experiment to make the experimental environment inert. Nitrogen is used as the compressed gas and this is fed into the system for several minutes before an experiment is started. This typically reduces the oxygen concentration to less than 4% and therefore reduces the potential for sustained combustion of any of the chemical samples during the test.

A cryogen may also be introduced into the air recirculation duct through a second valve 38, enabling the system to operate from low temperatures. For example, the cryogen may be liquid nitrogen, in which case the temperature could be as low as −196° C. The recirculation method makes the calorimeter highly energy efficient, limiting cryogen use to a minimum. A constant cryogenic start temperature can be achieved by controlling the rate at which the cryogen is bled into the recirculation duct.

Auxiliary equipment may also be added to the embodiment to provide variable speed stirring and agitation, reagent addition and safe gas/vapour release. Apart from the standard integral burst disk protection used to prevent test cells and equipment from being damaged, an explosion-proof sample chamber has also been developed for particularly energetic materials. These features enhance system performance and capabilities when the embodiments of the invention are used in certain applications.

Two features of embodiments of the invention are worthy of particular note. The first of these is the flow circuit that allows gas to be recirculated within the instrument. This is an arrangement that draws upon the inherent control stability of closed-loop systems, thereby enhancing performance of the instrument by adjusting for changes in the behaviour of the system as distinct from changes arising from the reaction of the sample and/or the environment in which the equipment is located. This gives embodiments of the invention a very stable and controllable thermal baseline, minimising control errors through the physical design such that the control algorithms do not stray to regions of resonance and/or instability. Consequently, the embodiment is capable of generating high-quality data with a high signal to noise ratio. The flow circuit creates a rapidly circulating air or gas stream of low heat capacity that is forced at high Reynolds numbers over the test-cells 36 containing the samples. The air stream is split and force circulated over the headpieces of the test cells 36. This ensures that the incidence of condensation and/or distillation errors, because of material displacement and/or heat displacement, is minimised. This is acknowledged to be a problem in known apparatus.

Apart from the control stability and the reduction of vapour phase experimental error, the provision of a flow circuit makes it possible to apply a combined heat flow plus heat balance analysis to the data collected during a test. This is so because the flow circuit provides a sound practical and theoretical basis for the determination of an overall heat flow coefficient (OHTC) during the test, which can then be used during the subsequent data analysis. The OHTC external component invariability is critical in this, since it is this parameter that limits the rate of heat flow (i.e., power) into and out of the test-cell 36 and sample. This is achieved by the flow circuit configuration. In this, the heated air stream flows over the heaters 24 and then through the blower 12 (a counter-intuitive sequencing of zones, with regard to designs of instruments in this field). This creates a homogeneous temperature regime, which in turn is passed through the turbulator 16. As a consequence, it is possible for the turbulator 16 to be designed as a region of high turbulence (and therefore thorough mixing) whilst maintaining a low pressure difference across it. With a stable external OHTC component guaranteed and an experimentally predictable internal OHTC component variation (which is typically negligible compared to the external OHTC), a software package known as the Rapid Analysis Platform (RAP) allows the user to handle the analysis data in a manner that can provide both thermodynamic and thermokinetic statistics. In addition to this, the RAP software allows the user to determine temperature onsets and other thermal hazard specific information.

The embodiment can be run in many configurations, providing a versatile platform for thermal stability screening. Currently, this embodiment can test up to six independent samples under identical thermal conditions simultaneously in a single instrument. The embodiment can be used with or without a temperature reference sample (or empty test-cell), although slightly improved data is typically obtained if one is present, especially when working at the higher heating rates. The use of such a reference provides the basis for the unique feature of providing a pressure reference alongside the usual temperature reference. A methodology therefore exists which allows the pressure record of the sample head space to be handled in a manner which splits the non-condensable gas fraction from the condensable vapour fraction. This is an important feature of the testing method employed by embodiments of the invention because the instrument ramps each sample through an identical thermal history, an achievement attributable to the use of a gas-flow circuit which provides a well-controlled uniform temperature within the instrument.

In a typical experiment, the pressure reference sample may include a primary solvent or mixture of solvents. However, where applicable, inert components that are also present in the test sample may also be added, such that the vapour pressure variation with temperature matches that of the test sample as closely as possible. The validity of this approximation can be cross-checked against the test sample vapour pressure behaviour, as observed during the test before any reaction is detected. A second pressure reference with a pre-reacted sample mixture may also be used if so desired, to check for any effects of the products on the vapour pressure. Again, this can be achieved by virtue of the flow circuit and the multi-sample handling capability of the instrument.

The invention provides instruments designed to rapidly test the thermal stability of single materials and multicomponent mixtures. The flow circuit provides the instrument with a firm basis for control and mathematical modelling through use of the recirculation duct architecture. The flow circuit also provides the basis upon which the pressure reference methodology may be implemented successfully during real-time testing and within the analysis.

Examples of analyses performed in an embodiment of the invention will now be described.

An example of the differential pressure measurement technique is shown in FIG. 2. One sample is toluene (the solvent) and the other is 20% DTBP (an organic peroxide) with 80% toluene. By simply subtracting the two pressure curves, the additional pressure contribution from decomposition of the peroxide can be determined. This is the non-condensable gas product from the decomposition.

With reference to FIGS. 3 and 4, typical experimental data is shown from a sample of tests performed in the embodiment, in this case toluene vapour pressure and critical point. Because it is capable of handling multiple samples simultaneously, the embodiment can confirm results independently within a single test, such as with the determination of vapour pressures, melting points, boiling points, and so forth. Furthermore, differences in sample mass and/or composition can be used to confirm mass-dependent and/or concentration-dependent properties, as well as points of thermodynamic state transitions such as critical points, and other properties.

Results from cryogenic operation are illustrated in FIG. 5. Samples can be cooled down to cryogenic temperatures. The air recirculation within the flow circuit provides an energy efficient means for doing this by direct injection of cryogen into the air stream. The system is set up such that a constant temperature baseline is established. This is again possible due to the deviation control architecture used as the basis of the design. To maximise cooling efficiency and minimise thermal shock, the flow of cryogen cools the heaters 24 before the rest of the instrument. The melting temperature profiles of a series of salt solutions of varying concentrations are shown in the FIG. 5. Each endotherm (represented in the figures as a flattening of the temperature profile) shows where the melting point of each sample lies. The latent heats of fusion for each process can be calculated from this data. The results are from a single test, and the experiment was conducted from a temperature of −110° C. to a temperature of 40° C.

FIGS. 6 and 7 illustrate results from a typical experiment performed upon Di-tert Butyl Peroxide in Toluene, in which a number of samples plus a chemical reference are ramped at 5° C./min. The deviations from around 140° C. to 170° C. show exothermic activity due to an exothermic reaction reaction/decomposition of the sample material. The system is then cooled. From this data, it is possible to calculate a number of thermodynamic properties (such as heat of reaction) of each sample as well as a number of thermokinetic parameters (such as activation energy).

1. A calorimeter comprising:
a sample chamber having a gas inlet and a gas outlet;
a flow duct interconnecting the gas inlet and the gas outlet to form a flow circuit with the sample chamber;
a circulation pump within the flow circuit operable to cause gas to flow into the gas inlet;
a heater to heat gas flowing within the flow circuit;
and a sensor operable to detect the temperature of a sample within the sample chamber, wherein the flow circuit, during use, is sealed such that gas within it is retained for circulation by the circulation pump, the gas being heated by the heater before passing into the sample chamber to transfer heat to a sample therein.

2. The calorimeter according to claim 1 further comprising a sensor operable to detect the temperature of the gas flowing.

3. The calorimeter according to claim 1 further comprising a sensor operable to detect the pressure of gas flowing within the flow circuit.

4. The calorimeter according to claim 1 further comprising means for inducing turbulence in gas flowing within the flow circuit.

5. The calorimeter according to claim 4 in which the means for inducing turbulence is disposed between the circulation pump and the sample chamber.

6. The calorimeter according to claim 1 in which the sample chamber is configured to receive a plurality of separate samples.

7. The calorimeter according to claim 6 having a respective sensor to measure the temperature of each sample.

8. The calorimeter according to claim 1 in which the heater is disposed within the flow circuit upstream of the circulation pump.

9. The calorimeter according to claim 1 in which the flow circuit includes ducts that are insulated to reduce loss of heat from the gas flowing within the flow circuit.

10. The calorimeter according to claim 1 further comprising a port through which gas can be introduced into the flow circuit.

11. The calorimeter according to claim 1 further comprising a port through which a cryogen can be introduced into the flow circuit.

12. A method of performing an analysis on a sample, comprising:
a) placing the sample in the sample chamber of a calorimeter according to any preceding claim;
b) operating the pump to cause gas to flow within the flow circuit;
c) operating the heater to convey heat to the gas flowing within the flow circuit; and
d) using a sensor to monitor the temperature of one or more of the sample and the gas flowing within the flow circuit.

13. The method according to claim 12, further comprising using a sensor to monitor a reference temperature.

14. The method according to claim 12 in which, prior to step (b), an inert gas is introduced into the flow circuit.

15. The method according to claim 14 in which the inert gas is nitrogen.

16. The method according to claim 12 in which, prior to step (b), a cryogen is introduced into the flow circuit.

17. The method according to claim 16 in which the cryogen is liquid nitrogen.

18. The method according to claim 12 further including, in step (d), measuring the pressure of gas within the flow circuit.

19. The method according to claim 12 in which, in step (a), a plurality of samples are placed in the sample chamber, and in step (d), the temperature and/or pressure of each sample is measured individually.

20. The method according to claim 12 in which the heater is operated to raise the temperature of a reference or a sample at a constant rate.

21. The method according to claim 12 in which the heater is operated to maintain the temperature of a reference or a sample at a constant temperature during part of the analysis.

22. The method according to claim 12 in which the measured temperature and/or pressure is recorded as a function of time.

23. The method according to claim 12 in which a reference sample is additionally introduced into the sample chamber, and its temperature is measured during performance of the method.
